(19) United States
(12) Patent Application Publication
(10) Pub. No.: US 2012/0303901 A1
(43) Pub. Date: Nov. 29, 2012

(54) Distributed caching and analysis system and method

(76) Inventors: Qiming Chen, Cupertino, CA (US); Meichun Hsu, Los Altos Hills, CA (US)

(21) Appl. No.: 13/118,392

(22) Filed: May 28, 2011

(51) Int. Cl. G06F 12/08

(52) U.S. Cl. 711/126; 711/E12.02

(57) ABSTRACT

Distributed caching and analysis system and method are disclosed. In an example, a method for distributed caching and analyzing includes processing a local data partition on a distributed caching platform (DCP) by a query engine at each node in the DCP. The method also includes aggregating query results for a client from multiple nodes in the DCP for real-time, parallel analytics.

### BACKGROUND

With advances in processing, memory, and connectivity technologies, software applications are becoming increasingly distributed, data-centric, and web-based. Applications known as Extreme Transaction Processing (XTP) applications, support a large number of users, offer high performance, high availability, scalability, and low latency data access. Typical modern relational databases have shown poor performance for some data-intensive operations, including applications which index a large number of documents, those which serve pages on high-traffic websites, and those which deliver streaming media, to name only a few examples.

Due to the ever increasing volume of data, and the pressing need for low latency in web applications, conventional Structured Query Language (SQL) databases are too rigid and complex. An industry trend is to relax the strict ACID (atomicity, consistency, isolation, durability) properties and replace traditional SQL with simplified APIs. It is noted that the acronym “ACID” is a set of properties that help ensure database transactions are processed reliably. This trend has resulted in a paradigm shift in data management, referred to as “NoSQL.” NoSQL differs from classic relational database management systems in several ways. For example, NoSQL may not use fixed table schemas, and usually avoid using join operations. NoSQL also scale horizontally across multiple machine nodes. These NoSQL systems are referred to as disk-based data stores.

NoSQL systems typically operate with column-based data stores and data access application programming interfaces (API). These systems, developed independently, use similar concepts to achieve multi-row distributed ACID transactions, with snapshot isolation guarantee for the underlying column store. These systems avoid extra overhead of data management, middleware system deployment, and maintenance introduced by a middleware layer. In addition, NoSQL systems employ a distributed architecture, with data being held in a redundant manner on several servers (e.g., using a distributed hash table). In this way, the system can readily be scaled by adding more servers, and the failure of a single server can be tolerated well. But NoSQL architectures often provide weak consistency guarantees (e.g., eventual consistency), and transactions are often restricted to single data items.

### BRIEF DESCRIPTION OF THE DRAWINGS

FIG. 1 is a high-level illustration of an example Distributed Caching Platform (DCP) cluster.

FIG. 2a shows a graph-structured dataflow 200 with multiple queries cascaded based on accessing the shared cache supported by DCP.

FIG. 2b illustrates another graph-structured dataflow using the cache for both a data source and as a sink for a query.

FIG. 3 shows an example query process (QP) for network traffic analysis.

FIG. 4 is an illustration of a data read/write operation from/to a table, and a data read/write data operation from/to a cache.

FIG. 5 illustrates operation of an example support QP based on memory sharing provided by DCP.

FIG. 6 is a flowchart illustrating exemplary operations which may be implemented for distributed caching and analysis.

### DETAILED DESCRIPTION

The demand to support a large number of users at high performance, requires large scale, high availability, and low latency data access. Distributed Caching Platform (DCP) is a memory-based alternative to disk-based NoSQL data stores. DCP commonly employs a column-oriented, Key-Value (KV)-based data model, and simple read/write (R/W) APIs. In the past, DCP has only been used for simple online transaction processing (OLTP) operations.

However, DCP may also be used to exploit the advances in memory and networking technologies by combining memory on multiple machines into a single, unified global memory. DCP provides replicated and distributed (or partitioned) data management and caching services on top of a reliable, highly scalable peer-to-peer clustering protocol. DCP has no single points of failure. DCP automatically and transparently fails over and redistributes clustered data management services when a server becomes inoperative or is otherwise disconnected from the network. When a new server is added, or when a failed server is restarted, the server automatically joins the cluster.

This architecture can be used to provide data access at low latencies, and can be used for XTP applications, or other real-time, complex analytic applications that can implement incremental scalability, high availability and low latency. Example systems and methods described herein utilize simple KV based R/W APIs, introduce analytics capability to DCP, and handle graph-structured data flows by leveraging DCP memory sharing characteristics. DCP may be used as a unified share memory across multiple nodes for multiple cascaded queries to communicate. For example, query A reads the result of query B as query A's input, even if A and B are run by separate query engines on different nodes.

To support highly parallel and distributed, incrementally scalable, memory-based efficient data-intensive analytics, the systems and methods described herein combine SQUNoSQL interfaces and integrate the DCP engines with the SQL query engines. As such, the systems and methods described herein broaden the reach of DCP to analytics, and Integrate SQL/NoSQL for memory based near-real-time analytics.

In an example, the query engine is extended to a Cache-oriented Analytic Engine (CAE). The CAE reads source data from the DCP and writes results to the DCP, while preserving the SQL expressive power (e.g., where the analytic tasks not directly expressed by SQL can be coded by user defined functions (UDF)). Each DCP node can be provided with a CAE, toward the Distributed Caching and Analyzing Platform (DCAP). The systems and methods support graph-structured an Analytic Query Process (AQP) that involve multiple cascaded individual queries, using DCP as a shared memory for caching the source and destination data for these queries in the programming paradigm of “everyone talks to the sharable data cache”.

Accordingly, the query engine provides the capability of executing SQL/UDF expressed analytical dataflow. DCAP provides a powerful combination of both real-time and parallel analytics. With DCAP, DCP and SQL benefit each other by increasing the reach of DCP to SQL query-based analytics. In addition, the query engine capability is enhanced for executing AQP involving multiple individual queries linked via shared caches.

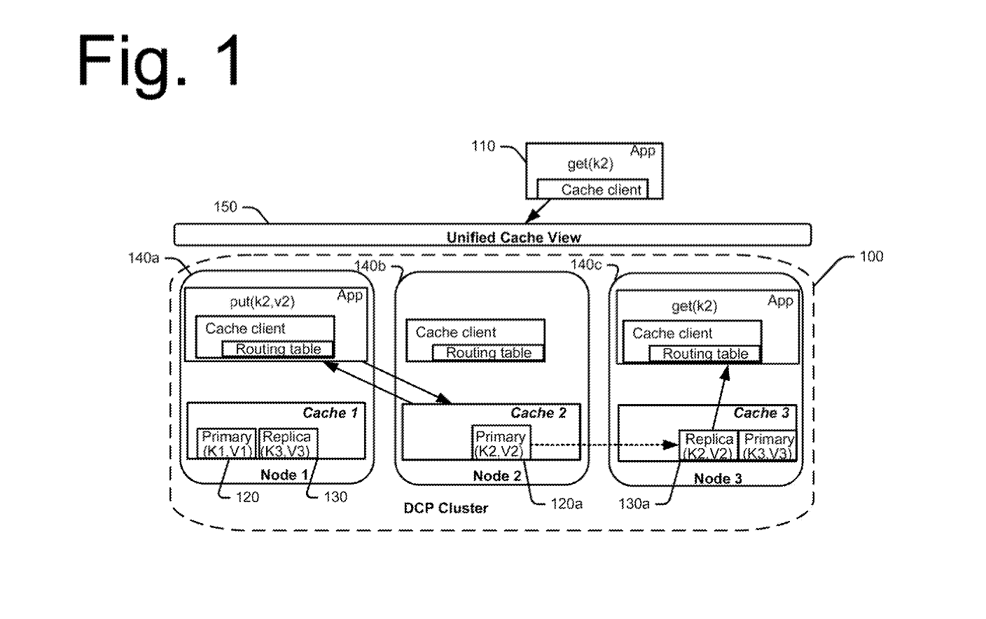

FIG. 1 is a high-level illustration of an example DCP cluster 100. In general, the distributed applications 110 span machines and tiers. Data and application components can reside in different tiers with different semantics and access patterns.

Typically, there tends to be single “authoritative” source for any data instance, e.g., shown as primary source 120 shown in FIG. 1. For example, data stored in a backend database may be considered “authoritative,” and therefore needs to have a high degree of data consistency and integrity. Data in the mid-tier (e.g., operated by a business) can be a copy of the “authoritative” data. The copies are known as “reference” data, e.g., shown as replica 130 shown in FIG. 1. The “reference” data is suitable for caching, and thereby supports low latency access to the data.

Accessing large sets of backend data by many operations can be process intensive, and therefore can significantly impact the response time and throughput of the application 110. For example, most data is either shared reference data or exclusive activity data, which can be cached for low latency access. In order to provide availability for the cached data, these caches are distributed and replicated in the DCP infrastructure 100, e.g., as illustrated by primary source 120a and replica 130a.

In a DCP cluster 100, data is often replicated to multiple nodes 140a-c for failover management. The locality of data is transparent to users, as illustrated in FIG. 1 by the “unified cache view” 150. For example, a user can be assigned a “static cache,” which can be located on one or more node (e.g., Cache 1 on node 140a in FIG. 1) and accessed from a cache on another node (e.g., Cache 2 on node 140b in FIG. 1). This architecture is often referred to as an “elastic cache”. A DCP 100 having such a property is referred to as an Elastic Caching Platform (ECP). It is noted, however, that the term “DCP” is used herein to refer generally to both DCP and ECP.

The DCP provides APIs for data access, such as get( ) put( ) delete( ) etc. Below are some examples of APIs which may be utilized in a DCP:

// Create instance of cachefactory (reads appconfig)

DataCacheFactory fac = new DataCacheFactory( );

// Get a named cache from the factory

DataCache catalog = fac.GetCache(“catalogcache”);

// Simple Get/Put.

catalog.Put(“toy-101”, newToy(“Puzzle”, .,.));

// From the same or a different client

Toy toyObj = (Toy)catalog.Get(“toy-101”);

// Region based Get/Put

catalog.CreateRegion(“toyRegion”);

// Both toy and toyparts are put in the same region

catalog.Put(“toy-101”, newToy( .,.), “toyRegion”);
Catalog.Put(“toypart-100”, newToyParts(...). “toyRegion”);
Toy toyObj = (Toy)catalog.Get(“toy-101”,“toyRegion”);

The following code adds tags to the items:

Tag hotItem = new Tag(“hotItem”);
catalog.Put(“toy-101”. new Toy(“Puzzle”),
new Tag[ ]{hotItem}, “toyRegion”);
catalog.Put(“toy-102”. newToy(“Bridge”), “toyRegion”);

// From the same or a different client

List<KeyValuePair<string, object>> toys =

catalog.GetAnyMatchingTag(“toyRegion”, hotItem);

It is noted that cached content may be read-through a database or written-through a database. While DCP has focused in the past on OLTP specifically, NoSQL and DCP address scalability, availability and high-performance parallel processing. However, there are some gaps between a NoSQL/DCP platform and an analytics platform. Analytic applications rely on complex data manipulation and may be applied to a group of data objects. From an analytics point of view, one limitation of NoSQL/DCP is that the NoSQL/DCP APIs (e.g. get( ), set( ), delete( )) are simple, handle one object at a time, and lack the SQL's expressive power for analytics. In addition, these APIs lack sophisticated data retrieval capability, which results in a one-by-one data movement between the DCP nodes 140a-c and the client 110. If the application is running outside of the DCP cluster 100, such data movement generates heavy network traffic and results in poor data analysis performance.

The systems and methods described herein take advantage of SQL and query engines for data-intensive analytics, while also implementing DCP for scalability and efficient data management, and pushing SQL-based real-time analytics down to the DCP layer.

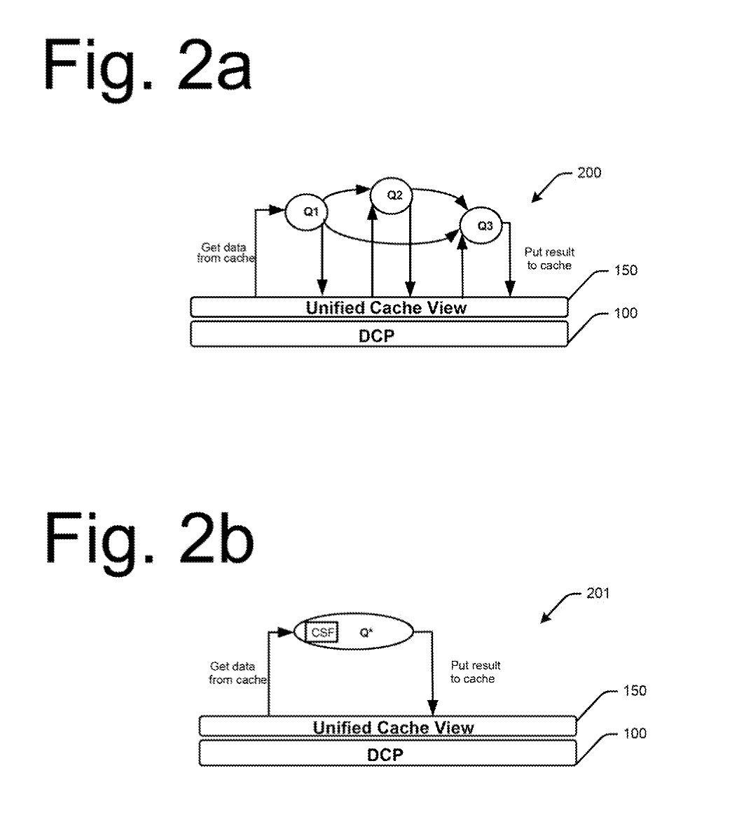

FIG. 2a shows a graph-structured dataflow 200 with multiple queries Q1-Q3 cascaded based on accessing the shared cache 150 supported by DCP. Like other applications, analytics applications benefit by caching data for improved performance. That is, the closer data is to the application code, the faster the application executes, by avoiding the access latency caused by disks and/or the network.

Local caching is considered to be the fastest, because the data is cached in the same memory as the code itself. However, the cache may be insufficient if the data is too big to fit in the application server memory space, if the cache is updated and shared by users across multiple application servers, or for failover scenarios without data loss. Accordingly, DCP may be used to bridge the need for a local cache.

As mentioned above, DCP is highly scalable, highly available, and offers an efficient data processing platform. The data access is memory-based, the data store is partitioned and replicated, so that operations can be parallelized. But current implementations of DCP are treated as a data-store, and therefore the APIs are very primitive and used only for handling key-value pairs, one at a time, which imposes a high-volume on server-client data communication. While such a limitation may be acceptable for OLTP applications, it is not appropriate for data-intensive analytics.

Accordingly, the systems and methods described herein implement DCP for real-time, efficient, parallel and scalable analytics. In addition, the systems and methods also integrate semantic-rich SQL queries and User Defined Functions (UDFs), with the existing DCP′ operations to provide expressive power for data analysis. The systems and methods also push data-intensive analytics down to the DCP layer for fast data access and reduced data transfer. The systems and methods also support a graph-oriented dataflow process with multiple queries and operations, cascaded through communicating via shared caches. The systems and methods also enable parallel analytics offered by DCP.

In an example, the systems and methods described herein integrate SQL with NoSQL platforms in a DCP infrastructure. The systems and methods may bundle a query engine (e.g., open-sourced PostgreSQL engine) with the DCP server on each node, to support the data-flow of analytics expressed by SQL queries and UDFs. The query engine at a node is a server-side, local DCP client responsible for processing the local data partition.

The query engine may also be used as a server-side, global DCP client, to aggregate the query results from multiple nodes. As a global DCP client, such a query engine can execute the query that reads input data from multiple, partitioned caches. Physically a query engine can act as a local engine, a global engine, or both.

The query engine may be embedded in the DCP using cache-scan (e.g., instead of table-scan) as an access method. In the graph-based dataflow, multiple queries cascade through cache write/read. Parallel analysis is supported by DCP. For example, the local query engines can run Map functions, and the global query engines can run Reduce functions.

It is noted that the systems and methods described herein do not merely integrate a DCP with an RDB data store, but integrate with the query engine for dataflow execution capability. Although it is noted that in an example, the DCP may still be connected to a data store (e.g., either SQL or NoSQL) for persisting data.

FIG. 2b illustrates another graph-structured dataflow 201 using the cache 150 for both a data source and as a sink for query Q*. In this example, the query Q* gets data from, and puts data to the cache 150 to avoid latency caused by accessing the data from disk. An analytic function may run on multiple nodes, and be applied to the data partitioned to these nodes, similar to how a Map function executes on each node for processing the local data. However, because the data is not necessarily on the same node in the DCP 100 as the application that is using the cached data, a network hop may be needed to access the data (refer to the illustration shown in FIG. 1). This is in contrast to a local cache that is always with the application. To overcome this network latency, the DCP may be configured to synchronize data with a local cache. The first time the application accesses the data, network hop is made to the node where the data resides. Then data can be accessed from a local cache that is synchronized with the cache cluster.

In addition, the DCP may be configured to have the data access made to local replicas. It is noted that data replication has trade-offs in maintaining consistency. Therefore, fault-tolerance options may be provided which are enabled by data replication. Data replicas ensure that if any node fails, the data can be accessed from another node. In addition to configuring the number of replicas, extended options such as configuring for synchronous or asynchronous replication may be supported.

The query engine may be extended for running queries in a DCP environment. The extended query engine is referred herein to as Cache-oriented Analytic Engine (CAE).

CAE starts by providing cached data for queries. The first step replaces the database table, which includes a set of tuples on disk, with a new table function, referred to herein as a Cache Scan Function (CSF). CSF returns a sequence of tuples forqueries from cached data which are column oriented key value pairs. A CSF can read data from the DCP cache using DCP APIs, by combining key-value pairs and converting those pairs to tuples. These tuples can be fed one-by-one to the query. Similar to a table scan function, the CSF may be called multiple times during the execution of a query. Each call returns one tuple. When an end-of-data condition arrives, the CSF signals the query engine to terminate the query execution.

DCP provides memory-based data source for queries, and particularly, a “single entrance” API to make location-transparent data access. In case the data is replicated, the local replica can be retrieved by default. This can be enforced by the underlying DCP.

The CSF scan is supported at two levels: (1) the function level, and (2) the query executor level. A data structure containing function call information (hFC) bridges these two levels. hFC is initiated by the query executor and passes in/out the CSF for exchanging function invocation related information. This mechanism may be used to minimize the code change, while maximizing extensibility of the query engine.

While the standard SQL engine includes a number of built-in analytic operators, the analytic operations not supported by SQL can be implemented using UDFs. In an example, a UDF may be provided with a data buffer in the function closure, and for caching stream processing state (synopsis). A scalar UDF is called multiple times on the per-tuple basis, following the typical FIRST_CALL, NORMAL_CALL, FINAL_CALL skeleton. The data buffer structures may be initiated in the FIRST_CALL, and used in each NORMAL_CALL. As an example, a window function defined as a scalar UDF incrementally buffers the stream data, and manipulates the buffered data chunk for the required window operation. In addition, the static data may be retrieved from the database and loaded in a window operation initially. The static data may be retained in the entire long-standing query, which removes much of the data access cost in multi-query-instances based stream processing.

Many analytic operations may be applied to a set of tuples. Accordingly, a new block UDF may be implemented. Operated in the query processing pipeline, a block UDF pools input tuples one chunk at a time, and performs analysis tasks on the chunk, either locally or by dispatching the data chunk to GPUs or an analytic engine in batch. The block UDF then materializes and streams out the results, e.g., tuple-by-tuple. This behavior makes the integration of analytic computation and data management more feasible.

A UDF can also use DCP to cache application-oriented data, either for handling history-oriented states across multiple calls of the UDF in processing multiple tuples, or for communicating with another UDF (e.g., for cache read/write). This greatly enhanced the UDFs capability and flexibility.

Based on the above approaches, DCP can now be used to support analytic applications. Analytic applications may implement stepwise information derivation from collected data. However, a single SQL query has limited expressive power at the process level, because it can only express tree-structured operations with coincident data flow and control flow. An intermediate query result cannot be routed to more than one destination and shared. However, an application often requires additional data flows between steps.

Accordingly, a Query Process (QP) may be used. A QP represents a data intensive application at the process level by one or more correlated SQL queries; which form sequential, concurrent or nested steps. A query may invoke UDFs, for example, relation-in/relation-out UDFs, referred to as Relation-Valued Functions (RVFs). The result-set of a query at a step becomes the data source of other queries at the successor steps.

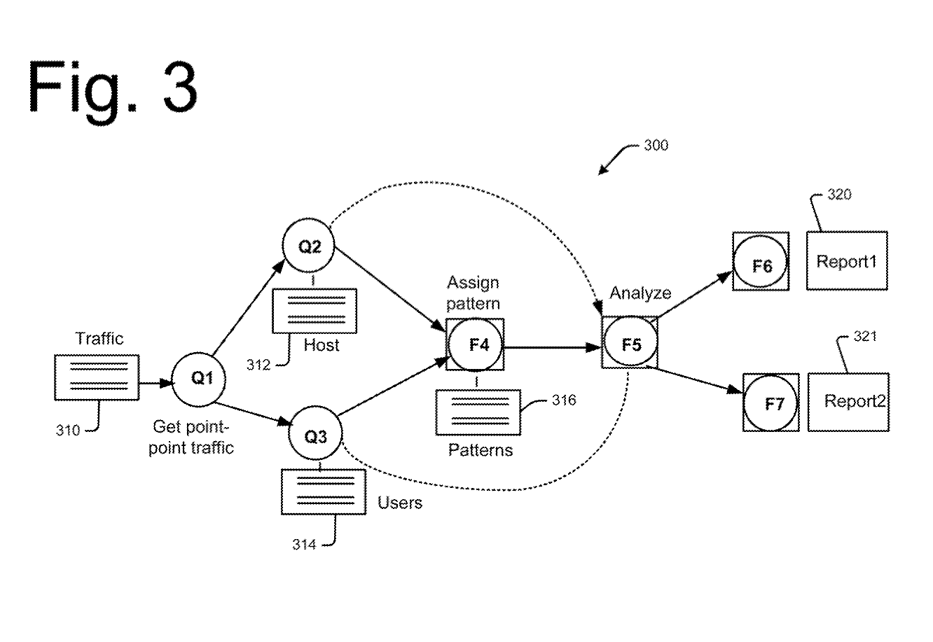

FIG. 3 shows an example query process (QP) 300 for network traffic analysis. In this example, Query Q1 captures point-to-point network traffic recodes by retrieving traffic detail record from the hourly traffic table 310. Query Q2 summarizes the host-to-host traffic volume 312. Query Q3 summarizes the user-to-user traffic volume 314. RVF F4 derives the user/host traffic pattern and finds the closest existing pattern 316. RVF F5 analyzes the traffic pattern with respect to the closest one. RVF F6 and F7 generate two kinds of traffic analysis reports 320 and 321.

Example pseudo code for the QP 300 shown in FIG. 3 is below. In this pseudo code, the definitions of operations F6, F7 use “in-line” specification for their input data sources:

Create Query Process Traffic_Analysis {

Source: Traffic, Hosts, Patterns, Users;
TRANSIENT;
Define Operation Q₁ As

SELECT from-ip, to-ip, SUM(bytes) AS bytes FROM Traffic

WHERE ... /* time- range */

GROUP BY from-ip, to-ip

Define Operation Q₂ As

SELECT h1.host-id AS from-host, h2.host-id AS to-host,
Q₁.bytes

FROM Q₁, Hosts h1, Hosts h2 WHERE h1.ip = Q₁.from-ip
AND h2.ip = Q₁.to-ip;

Define Operation Q₃ As

SELECT u1.user-id AS from-user, u2.user-id AS to-user,
Q₁.bytes

FROM Q₁, Users u1, Users u2 WHERE u1.ip = Q₁.from-ip
AND u2.ip = Q₁.to-ip;

Define Operation F₄ As

SELECT * FROM Assign_pattern (Q₂, Q₃, Patterns),

InputMode: BLOCK, ReturnMode: SET;

Define Operation F₅ As

SELECT * FROM Analyze (Q₂, Q₃, F₄),
InputMode: BLOCK, ReturnMode: SET;

Define Operation F₆ As

SELECT * FROM Report1 (“SELECT Attr1, Attr2, Attr3,
Attr4 FROM F₅”),
InputMode: BLOCK, ReturnMode: SET;

Define Operation F₇ As

SELECT * FROM Report2 (“SELECT Attr1, Attr2, Attr5,
Attr6 FROM F₅”),
InputMode: BLOCK, ReturnMode: SET;

}

The basic characteristics of a QP can be seen in the above example of QP 300. These characteristics include correlated queries and RVFs. At the process level, multiple correlated SQL queries Q1, Q2, Q3, and RVFs F4, F5, F6, F7 form the sequential or concurrent steps of the application, and complex data flows therebetween.

The characteristics also include separated control flows and data flows. Correlating multiple queries (including RVFs) into a process allows the data-flows to be expressed as control-flows. For example, the data-flows from Q2 and Q3 to RVF F5 takes F4 as well as Q2 and Q3 results as input. To ensure the involved queries and RVFs are executed only once, the application cannot be expressed by a single SQL statement, but rather by a list of correlated queries at the process level.

The characteristics also include data dependency driven control flows. If an operation (e.g., either a query or an RVF) has inputs from multiple predecessor operations, then the operation is eligible for execution when all predecessors have produced output (referred to as a “join”). For instance, the invocation of F4 follows the executions of Q2 and Q3. Likewise, the invocation of F5 follows the execution of F4, which occurs after the execution of Q2 and Q3. If an operation has multiple successor operations, then the output is replicated and sent to all successors as input (referred to as a “fork”). This can be seen in FIG. 3, where the results of Q2 and Q3 are delivered to both F4 and F5, and the result of F5 is delivered to both F6 and F7.

The result of a query or an RVF is produced only once, but may be consumed by multiple successors, for which a caching mechanism may be implemented.

The characteristics also include SQL as QP Constructor. In a QP pipeline, the data flowed through operations can be “ETLed” by SQL queries, such as F6 takes the filtered result from F5, as SELECT*FROM Report1 (“SELECT Attr1, Attr2, Attr3, Attr4 FROM F5”).

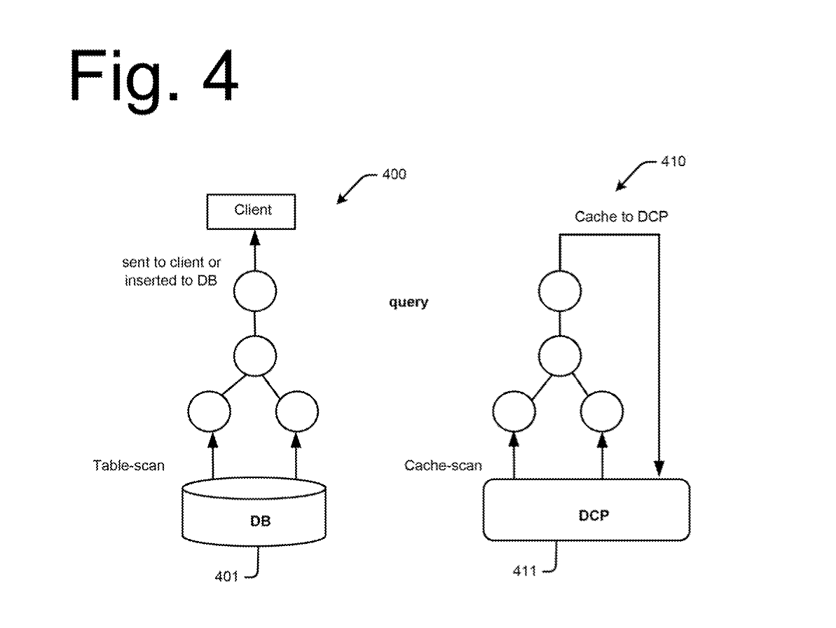

FIG. 4 is an illustration of a data read/write operation 400 from/to a table 401, and a data read/write data operation 410 from/to a cache 411. In order to support multiple queries-based dataflow with the query engine involves enabling cascading of multiple individual queries. The memory space of a single query is local to itself, but inaccessible by other queries. One exception is the shared scan feature supported by many query engines. This allows multiple queries to co-scan the same table 401, namely share the results of a single scan operation. However this feature is limited to the data access level. The general method for multiple queries to exchange results is by using tables. If such a table is defined as a regular table, the table may reside on disk by default, which imposes disk access cost and is more expensive than memory access. When such a table is used for holding intermediate data, it can be created and dropped after use. This imposes additional disk access cost. But if the table is defined as temporary table, the table resides in memory and cannot be accessed by other queries at all.

DCP provides a powerful support for cooperation of multiple queries. In an example, the query engine can be extended to allow the source data of a query to be read from the DCP cache using CSF as described above. Then the query results can be written to the DCP cache and read by other queries. In other words, DCP provides the shared memory space for every query.

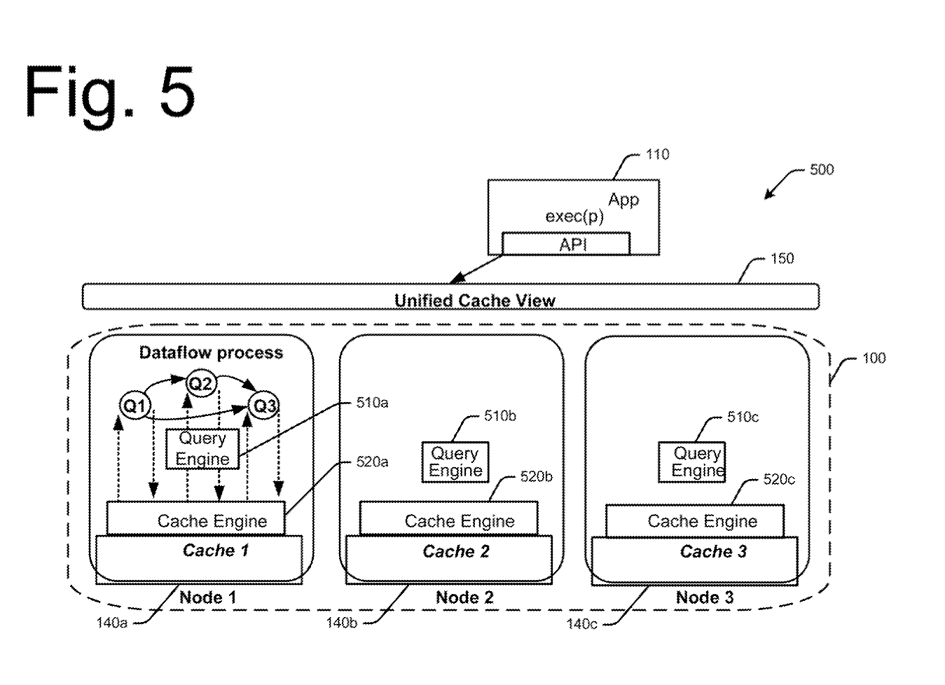

FIG. 5 illustrates operation of an example support QP 500 based on memory sharing provided by DCP. Here it can be seen that an exec( ) API can be added to the DCP engine for issuing a command to the DCP to execute a pre-specified QP. A scheduler is used for multiple queries orchestration.

One issue is how to determine the operation locality. For example, each node in the DCP cluster 100 may be provided with query engines 510a-c that can be used for executing the QP to access the respective cache via the cache engines 520a-c. If one query engine is needed, it should be located on the server where most of the source data is cached in order to enable efficient local cache scan.

It should be understood from the above description of the systems and methods for distributed caching and analysis, that the combination of DCP and SQL query engines can be used to support real-time, memory-based parallel and distributed data analysis applications. The systems and methods described herein broaden the reach of DCP to analytics from OLTP and Integrate SQL/NoSQL for memory based near-real-time analytics. In addition, the systems and methods extend the query engine to the CAE, which reads source data from DCP and writes results to DCP, while preserving the SQL expressive power (where the analytic tasks are not directly expressed by SQL and can be coded by UDFs). Each DCP node can be provided with a CAE, toward the Distributed Caching and Analyzing Platform (DCAP).

In addition, the systems and methods support a graph-structured QP, which involve multiple cascaded individual queries using DCP as shared memory for caching the source and destination data of these queries.

Before continuing, it is noted that the DCP supports in-memory data store, incrementally scalable data partition, parallel processing and elastic (single view with location transparency) data access. The QE provides the capability of executing SQL/UDF expressed analytical dataflow. DCAP provides a powerful combination of both DCP and QE for real-time, parallel analytics. With DCAP, DCP and SQL increases the reach of DCP to SQL query-based analytics. In addition, the query engine capability is enhanced for executing AQP involving multiple individual queries linked via shared caches. For example, distributed CAEs serve as parallel and distributed data processing where Map functions and Reduce functions are coded as queries/UDFs and executed by CAEs. The data transfers are made by write/read shared caches.

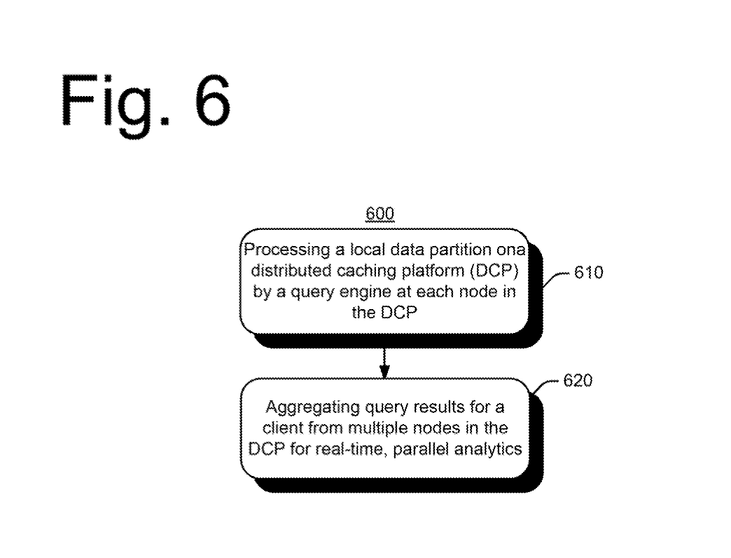

FIG. 6 is a flowchart illustrating exemplary operations which may be implemented for distributed caching and analysis. Operations 600 may be embodied as machine-readable code or logic instructions on one or more computer-readable medium. When executed on a processor, the logic instructions cause a general purpose computing device to be programmed as a special-purpose machine that implements the described operations. In an exemplary implementation, the components and connections depicted in the figures may be used.

In operation 610, processing a local data partition on a distributed caching platform (DCP) by a query engine at each node in the DCP. In operation 620, aggregating query results for a client from multiple nodes in the DCP for real-time, parallel analytics.

The operations shown and described herein are provided to illustrate exemplary implementations distributed caching and analysis. It is noted that the operations are not limited to the ordering shown. Still other operations may also be implemented.

In an example, further operations may include parallel processing and elastic data access. Further operations may also include executing an SQL/UDF expressed analytical dataflow. Further operations may also include reading source data from the DCP, and writing results to the DCP.

In an example, the query engine may executes AQP involving multiple individual queries linked via shared caches. In another example, the DCP provides an in-memory data store. In yet another example, the DCP provides an incrementally scalable data partition.

It is noted that the exemplary embodiments shown and described are provided for purposes of illustration and are not intended to be limiting. Still other embodiments are also contemplated.

1. A method of distributed caching and analysis, comprising:
processing a local data partition on a distributed caching platform (DCP) by a query engine at each node in the DCP; and
aggregating query results for a client from multiple nodes in the DCP for real-time, parallel analytics.

2. The method of claim 1, further comprising parallel processing and elastic data access.

3. The method of claim 1, further comprising executing an expressed analytical dataflow.

4. The method of claim 1, further comprising:
reading source data from the DCP; and
writing results to the DCP

5. The method of claim 1, wherein the query engine executes multiple individual queries linked via shared caches.

6. The method of claim 1, wherein the DCP provides an in-memory data store.

7. The method of claim 1, wherein the DCP provides an incrementally scalable data partition.

8. A system of distributed caching and analysis, comprising:
a distributed caching platform (DCP) server; and
a query engine on the DCP server to read source data from the DCP server and write results to the DCP server for real-time, parallel analytics.

9. The system of claim 8, wherein each node in the DCP server includes a query engine.

10. The system of claim 9, wherein the query engine at each node is a server-side, local client for processing a local data partition on the DCP server.

11. The system of claim 8, wherein the query engine is a Cache-oriented Analytic Engine (CAE).

12. The system of claim 8, further comprising a server-side, global DCP client to aggregate query results from multiple nodes.

13. The system of claim 12, wherein the server-side, global DCP client executes a query to read input data from multiple, partitioned caches.

14. The system of claim 8, wherein the query engine is both a local query engine and a global query engine.

15. The system of claim 8, wherein the query engine uses cache scan as an access method.

16. The system of claim 8, wherein multiple queries cascade through cache write/read in a graph-based dataflow.

17. The system of claim 8, wherein a local query engine runs Map functions and a global query engine runs Reduce functions for parallel analysis.

18. A system of distributed caching and analysis, comprising:
a distributed caching platform (DCP);
a query engine at each node in the DCP to process a local data partition on a distributed caching platform (DCP); and
a global DCP client to aggregate query results from multiple nodes in the DCP for real-time, parallel analytics.

19. The system of claim 18, wherein each node in the DCP server includes a query engine.

20. The system of claim 19, wherein the query engine at each node is a server-side, local client for processing a local data partition on the DCP server.
